(19) United States
(12) Patent Application Publication
(10) Pub. No.: US 2025/0165896 A1
(43) Pub. Date: May 22, 2025

(54) VISUALIZATION OF SUSTAINABILITY GOALS

(71) Applicant: The Boeing Company, Arlington, VA (US)

(72) Inventors: Brianne Michelle Hebert, Lake Stevens, WA (US); Christopher Charles Michael Eastland, Kenmore, WA (US); Reyn Nicholas Fernandez, Seattle, WA (US); Erin Macdonald Horan Gutierrez, Edmonds, WA (US); Kelsea Michelle Ballantyne, Edmonds, WA (US)

(21) Appl. No.: 18/781,852

(22) Filed: Jul. 23, 2024

Related U.S. Application Data
(60) Provisional application No. 63/602,263, filed on Nov. 22, 2023.

(51) Int. Cl. G06Q 10/0637; G06Q 10/0639

(52) U.S. Cl. CPC G06Q 10/0637; G06Q 10/06393

(57) ABSTRACT

A computing system for visualizing sustainability goals stores a data model comprising a tiered hierarchy of sustainability categories. The system receives user input of a product description for a product, categorizes the product description using a tiered taxonomic hierarchy corresponding to the tiered hierarchy of sustainability categories, stores the product description in the tiered hierarchy of sustainability categories of the data model, generate at least one recommended action based on the data model and the user input, generates a sustainability statement indicating the at least one recommended action, and outputs the sustainability statement for visualizing the sustainability goals. The data model provides for a nesting of product description records within tiers of the tiered hierarchy of sustainability categories.

### CROSS REFERENCE TO RELATED APPLICATIONS

This application claims priority to U.S. Provisional Patent Application No. 63/602,263, filed Nov. 22, 2023, the entirety of which is hereby incorporated herein by reference.

### FIELD

The present invention relates generally to the field of sustainability management.

### BACKGROUND

Managing sustainability goals within an organization is an intricate task, often involving multiple stakeholders and various considerations across different domains such as environmental impact, social accountability, and governance. Traditional methods for managing sustainability are often fragmented and lack a comprehensive approach that integrates these different domains.

### SUMMARY

To address the above issues, a computing system for visualizing sustainability goals is provided, comprising processing circuitry and memory storing a data model comprising a tiered hierarchy of sustainability categories. The processing circuitry is configured to receive user input of a product description for a product, categorize the product description using a tiered taxonomic hierarchy corresponding to the tiered hierarchy of sustainability categories, store the product description in the tiered hierarchy of sustainability categories of the data model, generate at least one recommended action based on the data model and the user input, generate a sustainability statement indicating the at least one recommended action, and output the sustainability statement for visualizing the sustainability goals. The data model provides for a nesting of product description records within tiers of the tiered hierarchy of sustainability categories.

### BRIEF DESCRIPTION OF THE DRAWINGS

FIG. 1 is a schematic view showing a computing system according to an example implementation.

FIG. 2 is a schematic view showing the data model of FIG. 1 according to an example implementation.

FIG. 3 is a schematic view showing the data model of FIG. 1 according to an example implementation.

FIG. 4 is a schematic view showing the data model of FIG. 1 according to an example implementation.

FIG. 5 is a schematic view showing the data model of FIG. 1 according to an example implementation.

FIG. 6 is a schematic view showing the data model of FIG. 1 according to an example implementation.

FIG. 7 is a schematic view of the user interface of FIG. 1 according to an example implementation.

FIG. 8 shows a flowchart for a method according to one example implementation.

FIG. 9 shows a schematic view of an example computing environment in which the computing system of FIG. 1 can be enacted.

### DETAILED DESCRIPTION

In view of the above, a computing system 10 is provided for visualizing sustainability goals. The system 10 comprises a computing device 12 including processing circuitry 14, volatile memory 16, an input/output module 18, and non-volatile memory 24 storing an application 26 including a data model 28. The data model 28 comprises a tiered hierarchy of sustainability categories 30, 32, 34. The processing circuitry 14 configured to receive user input 52 of a product description 54 for a product 60, and categorize the product description 54 using a tiered taxonomic hierarchy corresponding to the tiered hierarchy of sustainability categories 30, 32, 34. The product description 54 is stored in the tiered hierarchy of sustainability categories 30, 32, 34 of the data model 28.

The processing circuitry 14 then determines recommended executable actions 46 based on the data model 28 and the user input 52, generates a sustainability statement 64 indicating the recommended executable actions 46, and outputs the sustainability statement 64. The recommended executable actions 46 can include environmental benefits 46a and environmental impacts 46b of the product 60. Other recommended executable actions 46 can involve maintaining existing measures or taking no new actions.

A communications bus 20 can operatively couple the processing circuitry 14, the input/output module 18, and the volatile memory 16 to the non-volatile memory 24. Although the data model 28 is depicted as hosted (i.e., executed) at one computing device 12, it will be appreciated that the data model 28 can alternatively be hosted across a plurality of computing devices to which the computing device 12 is communicatively coupled via a network 22.

As one example of one such other computing device, a client computing device 48 can be provided, which is operatively coupled to the computing device 12. In some examples, the network 22 can take the form of a local area network (LAN), wide area network (WAN), wired network, wireless network, personal area network, or a combination thereof, and can include the Internet. The client computing device 48 can execute an application client 26A to receive user input 52 of a product description 54 for a product 60.

The computing device 12 comprises processing circuitry 14 and a non-volatile memory 24 configured to store the data model 28 in non-volatile memory 24, which retains instructions stored data even in the absence of externally applied power, such as FLASH memory, a hard disk, read only memory (ROM), electrically erasable programmable memory (EEPROM), etc. The instructions include one or more programs, including the data model 28 and the application 26 and data used by such programs sufficient to perform the operations described herein.

The user interface 50 can be provided on the client computing device 48 to display a tableau or matrix that creates a dashboard or visualization. This dashboard can be populated by data stored in the data model 28, which can be embodied as an SQL server database. The user inputs 52 that is inputted into the interface 50 can include a role 56 of the user in the organization, the product 60, a sustainability theme 58 associated with the product 60, and a time frame 62 for the executable actions 46. The user inputs 52 can be stored in the data model 28. The system 10 generates a comprehensive sustainability statement 64 based on the user inputs 52. When the user input 52 originates from documented sources, then the integrity of the generated sustainability statement 64 can be ensured.

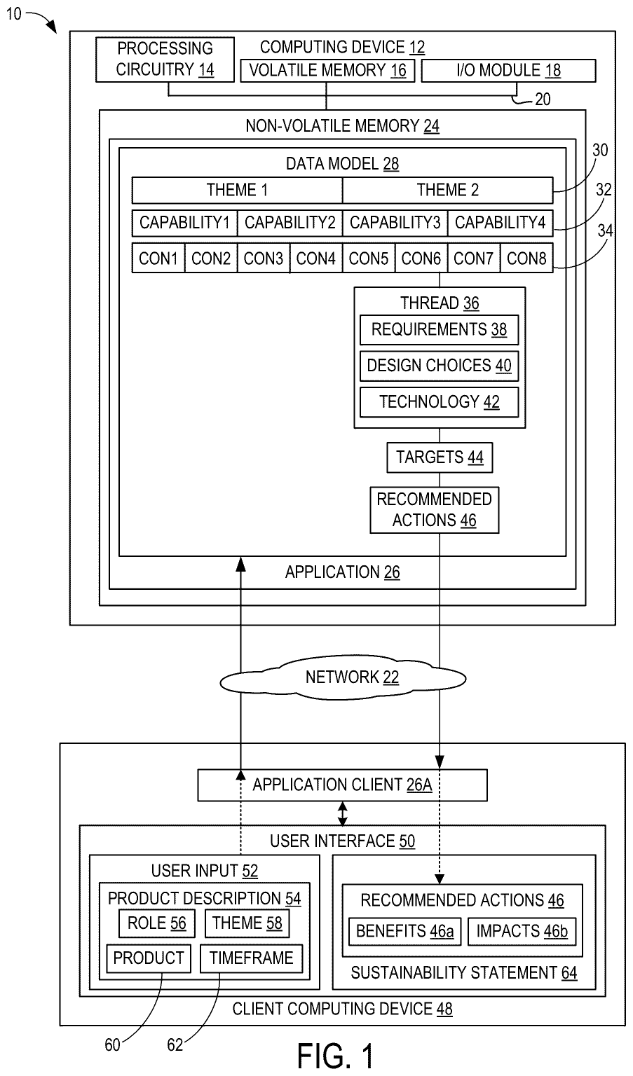

The data model 28 provides for a nesting of product descriptions 54 within tiers of the tiered hierarchy of sustainability categories 30, 32, 34. Although three tiers are depicted in the example of FIG. 1, it will be appreciated that the number of tiers in the tiered hierarchy is not particularly limited, and can number more than three. The data model 28 can comprise a matrix including a plurality of executable actions 46 and consideration categories 34. These executable actions 46 can be generated based on various themes 30 which are each aligned to different sustainability priorities. These executable actions 46 can be assigned to teams within an organization, for example.

As shown in the example of FIG. 1, in the data model 28, the first capability and the second capability are nested within the first theme. Likewise, the third capability and the fourth capability are nested within the second theme. The first and second considerations are nested within the first capability, the third and fourth considerations are nested within the second capability, the fifth and sixth considerations are nested within the third capability, and the seventh and eighth considerations are nested within the fourth capability.

The categorization of the product description 54 uses an algorithmic process which considers the targets 44, requirements 38, design choices 40, and technologies 42 of the product 60 to generate recommendations of executable actions 46 that are associated with the product 60. In the example of FIG. 1, the product description 54 is categorized into the second theme, the third capability, and the sixth consideration. The thread 36 associated with the sixth consideration is retrieved, which includes the requirements 38, design choices 40, and/or technologies 42 associated with the sixth consideration and the product 60. Based on the retrieved requirements 38, design choices 40, and/or technologies 42, at least one target 44 is identified. Then recommendations of executable actions 46 that are associated with the product 60 are generated based on the at least one target 44.

The sustainability statement 64 generated by the system 10 indicate the recommended executable actions 46, and can also indicate the environmental benefits 46a and the environmental impacts 46b associated with the product description 54 of the product 60. The outputted sustainability statement 64 is based on assessments carried out via the themes 30, capabilities 32, and considerations 34 as defined in the data model 28.

The recommended executable actions 46 included in the sustainability statement 64 providing a clear and structured path towards meeting the set targets 44. Regular monitoring and reporting can be established to track progress against these goals, and the data model 28 can be updated to reflect advances in technology and changes in regulatory standards, ensuring that the data model 28 remains a dynamic and effective tool for environmental responsibility.

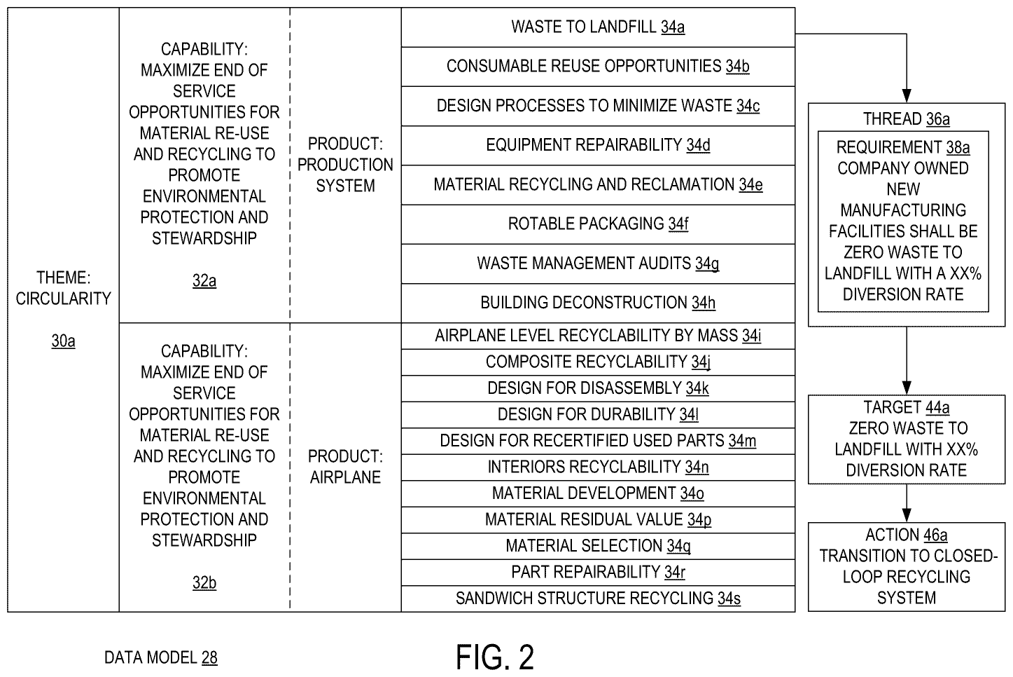

FIG. 2 gives an example of a data model 28, in which there is a ‘circularity’ theme category 30a encompassing two capabilities 32a, 32b for two products, respectively: a production system and an airplane. The two capabilities 32a, 32b are to maximize end of service opportunities for re-use and recycling to promote environmental protection and stewardship. For the production system product, the considerations include ‘waste to landfill’ 34a (strategies to minimize waste destined for landfill), ‘consumable reuse opportunities’ 34b, ‘design processes to minimize waste’ 34c, ‘equipment repairability’ 34d, ‘material recycling and reclamation’ 34e, ‘rotable packaging’ 34f (strategies for using rotable packaging that can be returned or reused), ‘waste management audits’ 34g, and ‘building deconstruction’ 34h for the repurposing of building materials.

For the airplane product, the considerations include ‘airplane level recyclability by mass’ 34i, ‘composite recyclability’ 34j (recycling of composite materials used in construction), ‘design for disassembly’ 34k, ‘design for durability’ 341, ‘design for recertified used parts’ 34m, ‘interiors recyclability’ 34n, ‘material development’ 340, ‘material residual value’ 34p, ‘material selection’ 34q, ‘part repairability’ 34r, and ‘sandwich structure recycling’ 34s.

Within the framework of the data model 28, the ‘circularity’ category 30a is a thematic class that encapsulates the environmental considerations of products throughout their lifecycle. The capabilities 32a, 32b associated with the ‘circularity’ category 30a particularly focus on maximizing end-of-service opportunities for reuse and recycling.

The data model 28 is configured to guide the categorization of products into sustainability tiers, with specific considerations tailored to the product type. This facilitates an assessment that is both comprehensive and nuanced, promoting environmental protection and stewardship as a core value of product development and usage.

In the illustrative example of FIG. 2, the data model 28 has categorized a product into a capability category 32a for the production system product and into the ‘waste to landfill’ consideration category 34a. The associated thread 36a includes a stringent requirement 38a that new manufacturing facilities must operate under a zero waste to landfill policy with an ambitious diversion rate target. This sets a clear directive to generate and execute actions 46a that would culminate in the reduction of waste sent to landfill. Accordingly, a target 44a is identified to achieve zero waste to landfill with a high diversion rate of XX %.

An example of an action 46a that can be executed to meet this ambitious target 44a includes transitioning to a closed-loop recycling system within the production facilities. This action 46a can include a meticulous waste audit to ascertain the composition and sources of waste generated, forming partnerships with material recovery facilities to ensure the efficient recycling of waste, redesigning equipment and facilities with modularity in mind, investing in advanced material recovery technologies, and developing a reverse logistics network to ensure the effective return and recycling of rotable packaging and parts.

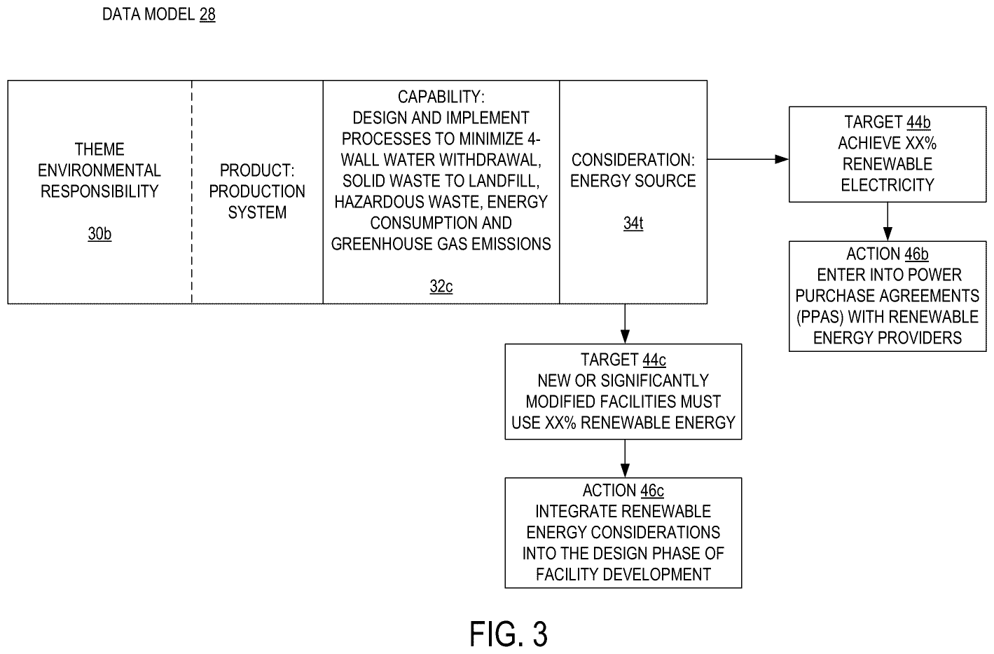

Turning to FIG. 3, the data model 28 can also include an ‘environmental responsibility’ theme 30b which emphasizes the importance of responsible resource management within the confines of the production facility, often referred to as ‘within the four walls.’ Under this theme 30b, the capability category 32c for the production system product can focus on the design and implementation of processes that effectively minimize four-wall water withdrawal, solid waste to landfill, hazardous waste generation, energy consumption, and greenhouse gas emissions. The ‘energy source’ consideration category 34t for this capability category 32c can encompass the energy consumption patterns of the production system and evaluations of the extent to which renewable energy sources are utilized.

In the illustrative example of FIG. 3, the data model 28 has categorized a product under the capability category 32c for the production system product and into the ‘energy source’ consideration category 34t. Accordingly, the data model 28 generates a target 44b to achieve XX % renewable electricity usage, and a target 44c to procure XX % of the energy for new or significantly modified facilities from renewable sources, ensuring that new developments are in line with sustainable practices from their inception.

To achieve the target 44b of XX % renewable electricity usage, several executable actions can be generated and recommended. One recommended action 46b can be to enter into power purchase agreements (PPAs) with renewable energy providers to secure a steady supply of green electricity. Other recommended actions can include investing in on-site renewable energy generation such as solar photovoltaic systems or wind turbines, and engaging in energy attribute certificate trading to supplement direct energy procurement with renewable energy certificates.

To achieve the target 44c that new or significantly modified facilities must use XX % renewable energy, a recommended executable action 46c can include integrating renewable energy considerations into the design phase of facility development. This can involve designing the building layout to maximize natural light, thereby reducing electricity demand, or installing energy-efficient HVAC systems that can be powered by renewable sources. Other recommended actions can include installing geothermal heating and cooling systems and adopting green building standards and certifications.

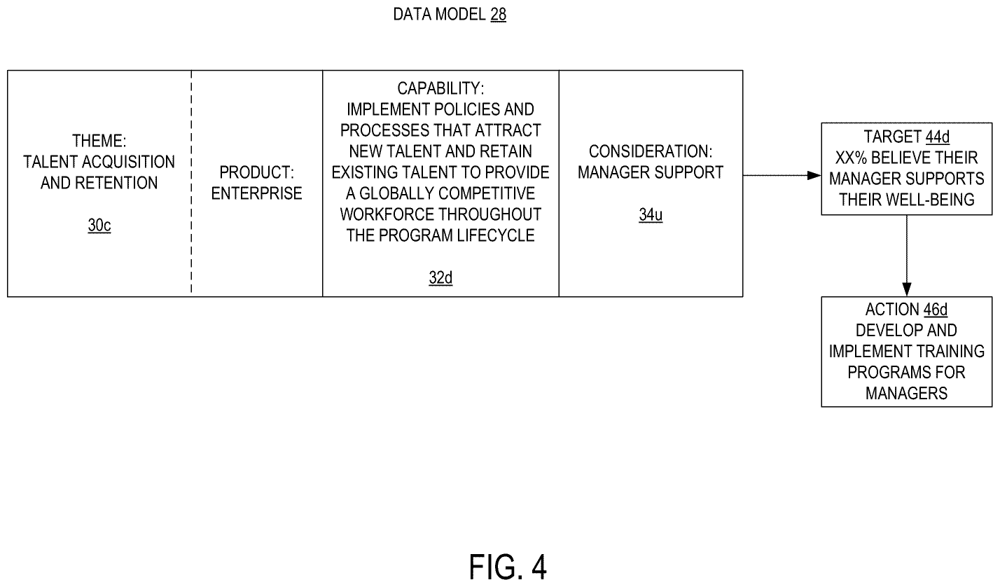

Turning to FIG. 4, the data model 28 can also include a ‘talent acquisition and retention’ theme 30c which is adapted for an enterprise product. This theme 30c underscores the strategic importance of human resource management within organizations, particularly in the context of fostering a globally competitive workforce. The capability category 32d under this theme 30c revolves around the implementation of policies and processes designed to attract new talent while retaining existing staff, ensuring that the workforce remains robust and dynamic throughout the program lifecycle. The consideration category 34u within this capability category 32d is ‘manager support,’ or focusing on the role of managerial staff in supporting and nurturing the well-being of their teams.

In the illustrative example of FIG. 4, the data model 28 has categorized the enterprise product into a capability category 32d for the enterprise product and into the ‘manager support’ consideration category 34u, and generated a recommended action 46d accordingly. In the context of the ‘manager support’ consideration category 34u, the data model 28 identifies a target 44d of ‘XX % of employees believe their manager supports their well-being.’ This target 44d is rooted in the understanding that employee perception of managerial support is critical to both their performance and their willingness to remain with the organization.

An example of a recommended action 46d that can be generated and executed to achieve this target 44d includes developing and implementing training programs for managers, which would focus on enhancing emotional intelligence, communication skills, and leadership abilities, thereby enabling managers to better support their team members.

Additional recommended actions that can be generated by the data model 28 include the introduction of regular one-on-one meetings between employees and their managers. These meetings would provide a platform for discussing not only work-related matters but also personal development and well-being. This approach can foster a culture of open communication and mutual trust.

Another recommended action that can be generated and recommended by the data model 28 involves the establishment of well-being programs. These programs might include mental health resources, stress management workshops, and initiatives promoting work-life balance. Managers would be trained to actively promote and encourage participation in these programs, demonstrating their commitment to the well-being of their team members.

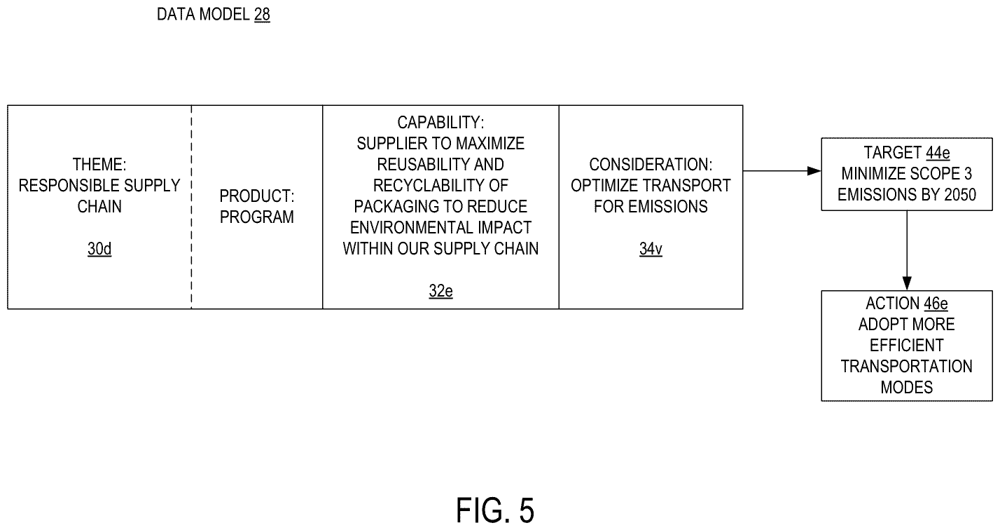

Turning to FIG. 5, the data model 28 can also include a ‘responsible supply chain’ theme 30d applied to a ‘program’ product. This theme 30d highlights the critical role of supply chains in environmental sustainability, with a specific focus on reducing the environmental impact of the program through sustainable practices. The capability category 32e within this theme 30d emphasizes the need for suppliers to maximize the reusability and recyclability of packaging, an approach integral to minimizing the ecological footprint of the supply chain. A consideration category 34v within this capability category is ‘optimize transport for emissions’, which concentrates on reducing the greenhouse gas emissions associated with the transportation of goods within the supply chain.

In the illustrative example of FIG. 5, the data model 28 has categorized a program product under the capability category 32e and into the ‘optimize transport for emissions’ consideration category 34v. Accordingly, the data model 28 generates a specific target 44e of minimizing Scope 3 emissions by the year 2050. Scope 3 emissions encompass indirect emissions that occur in a company's value chain, including those from transportation and distribution.

To work towards this ambitious target 44e, the data model 28 can generate several recommended actions. One such action 46e involves the adoption of more efficient transportation modes. For instance, transitioning from road transport to rail or sea freight, where feasible, can significantly reduce emissions due to the higher efficiency of these modes over longer distances.

Other recommended actions generated by the data model 28 can include the optimization of logistics and distribution networks. This could involve route optimization to reduce the distance traveled and the implementation of more efficient load planning to ensure that vehicles operate at full capacity, thereby reducing the number of trips required.

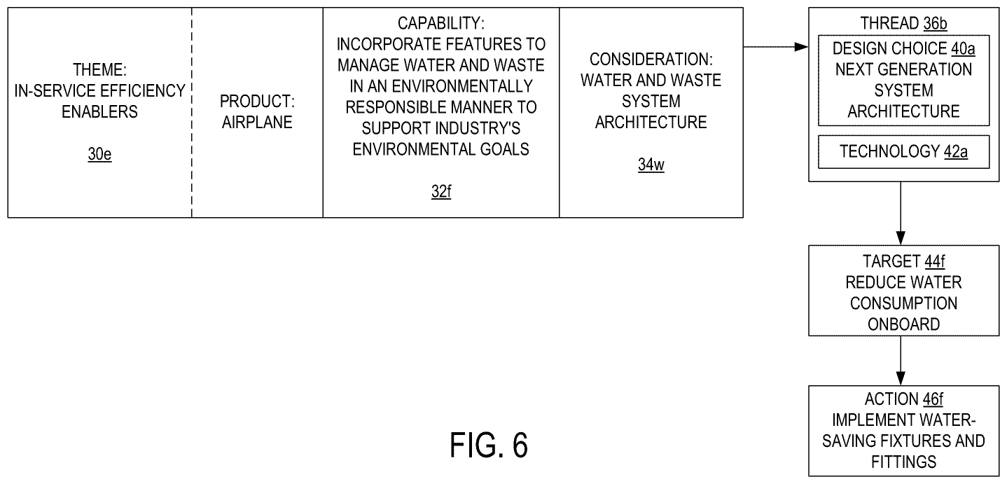

Turning to FIG. 6, the data model 28 can also include an ‘in-service efficiency enablers’ theme 30e, this time applied to an ‘airplane’ product. This theme 30e focuses on enhancing the environmental efficiency of airplanes while they are in service, aligning with the broader environmental goals of the aviation industry. The specific capability category 32f under this theme 30e emphasizes the incorporation of features that manage water and waste in an environmentally responsible manner.

Within this capability category 32f, the ‘water and waste system architecture’ consideration category 34w addresses the design and functionality of systems onboard the aircraft that handle water and waste, thereby ensuring that these systems contribute to environmental sustainability.

In the illustrative example of FIG. 6, the data model 28 has categorized an ‘airplane’ product under the capability category 32f for the ‘airplane’ product and into the ‘water and waste system architecture’ consideration category 34w. Accordingly, the data model 28 generates a thread 36b including a design choice 40a and a technology 42a imposed for this consideration category 34w. This design choice 40a and technology 42a dictate the adoption of ‘next generation system architecture’ in airplane design, which represents a forward-looking approach to environmental responsibility for reconfiguring the management of water and waste in airplanes, thereby aligning with the broader environmental objectives of the aviation industry. Based on the generated thread 36b, the data model 28 generates one or more targets 44f within this consideration category 34w.

When the target 44f is the reduction of water consumption onboard, the data model 28 generates a recommended executable action 46f that can include the implementation of water-saving fixtures and fittings, such as aerated faucets and low-flow toilets. Additionally, the introduction of water recycling systems that treat and reuse gray water for non-potable purposes can be recommended, thereby reducing the overall water consumption of the aircraft.

Through these targets 44 and their associated actions 46, as outlined in the data model 28 and described in the examples of FIGS. 2-6, there is a clear path toward advancing environmental sustainability in an organization or an industry by reducing environmental impacts. Regular updates and evaluations of these strategies, aligned with technological advancements and evolving environmental standards, can ensure that the data model 28 remains a dynamic and effective tool for environmental stewardship.

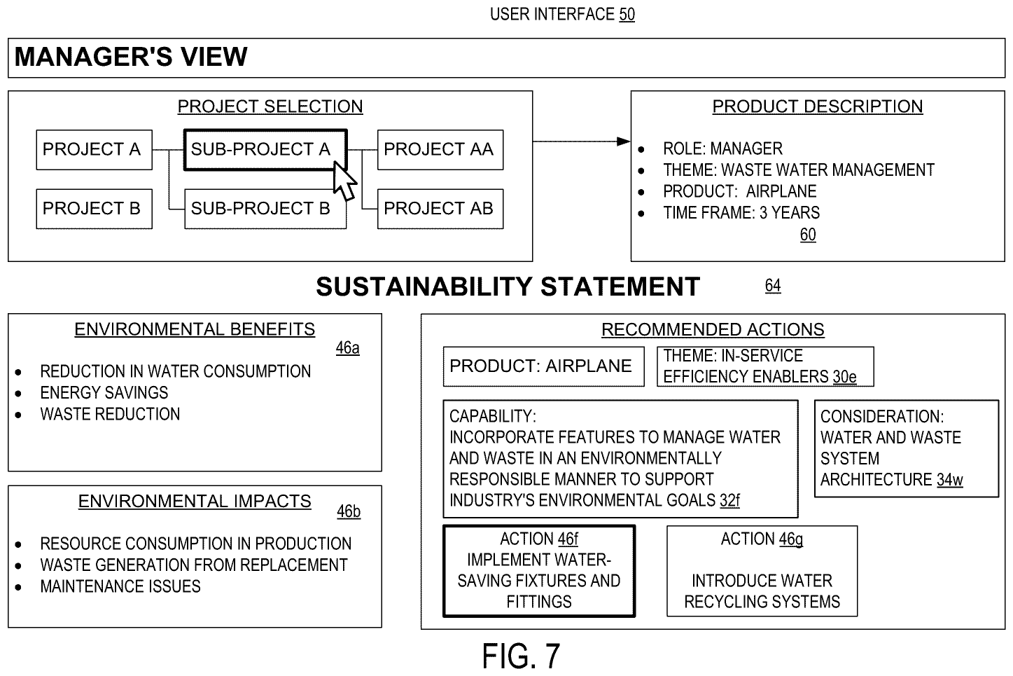

Referring to FIG. 7, an example implementation of the user interface 50 of FIG. 1 is shown illustrating the use of the sustainability categories of the data model illustrated in FIG. 6. In this example, the user interface 50 allows a user to view data collected and categorized for a plurality of projects and sub-projects, and the user can select recommended executable actions that would affect not only one project but also some of the sub-projects belonging to the project, and also view the assessed environmental benefits and impacts for each recommended executable action. Here, the user has selected a subproject A, which is part of project A, so that the user may view a sustainability statement 64 which is relevant not only to sub-project A, but also to projects AA and AB, which are encompassed by sub-project A. Here, the user enters a product description 60, which includes the role (manager) of the user, the product (airplane) being studied, the theme (waste water management) of the product, and the time frame (3 years) in which the recommended actions are to be executed.

Responsive to receiving user input of the product description, the data model generates and outputs recommended actions 46f, 46g as well as the sustainability categories 30e, 32f, 34w to which the product description 60 was categorized. The environmental benefits 46a and environmental impacts 46b can be generated and displayed for the selected action 46f. In this example, the user has selected the recommended executable action 46f of implementing water-saving fixtures and fittings. The potential environmental benefits 46a identified for this executable action 46f include ‘reduction in water consumption’, ‘energy savings’, and ‘water reduction’. The potential environmental impacts 46b identified for this executable action 46f include ‘resource consumption in production’, ‘waste generation from replacement’, and ‘maintenance issues’.

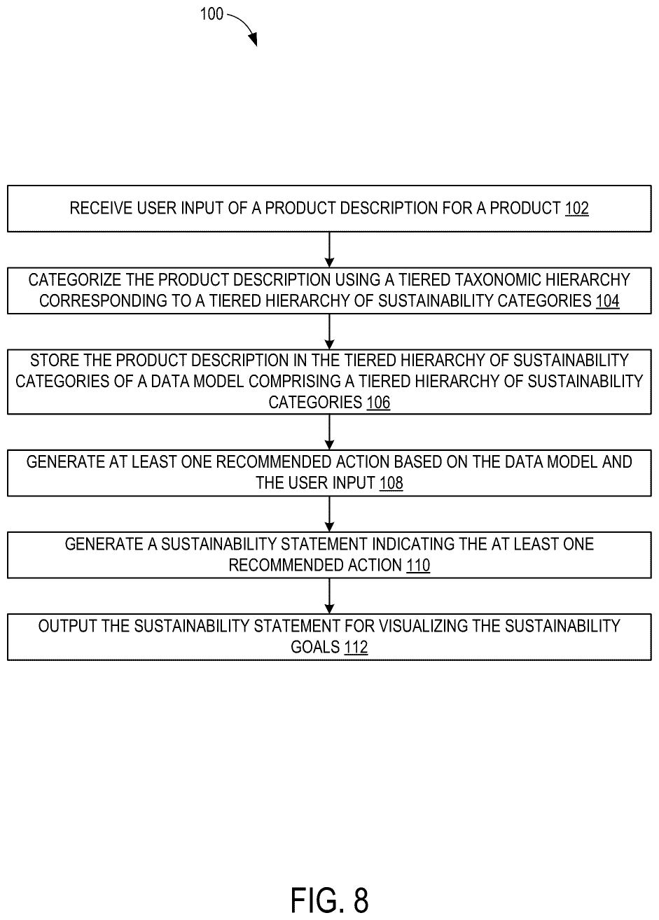

FIG. 8 is a flow chart that illustrates a method 100 for generating a sustainability statement is described. The method 100 can be implemented on the computing system 10 illustrated in FIGS. 1-6 above, which include processing circuitry and associated memory configured to implement a data model configured to generate a sustainability statement. Alternatively, other suitable computing hardware and software can be utilized.

At 102, the method includes receiving user input of a product description for a product. The user input can include at least one of a role, the product, a sustainability theme, or a time frame for the product. The user input can be inputted into a user interface configured to display a matrix populated by data stored in the data model.

At 104, the method includes categorizing the product description using a tiered taxonomic hierarchy corresponding to a tiered hierarchy of sustainability categories.

At 106, the method includes storing the product description in the tiered hierarchy of sustainability categories of a data model comprising a tiered hierarchy of sustainability categories. The data model provides for a nesting of product description records within tiers of the tiered hierarchy of sustainability categories, and the data model can be an SQL database.

The tiers of the data model can include a plurality of themes, each of the plurality of themes including a plurality of capability categories, and each of the plurality of capability categories including a plurality of consideration categories. The plurality of themes can include at least one of circularity, talent acquisition and retention, environmental responsibility, responsible supply chain, or in-service efficiency enablers. The plurality of consideration categories can include at least one of material recycling, material reclamation, or waste-to-landfill.

At 108, the method includes generating at least one recommended action based on the data model and the user input. The at least one recommended action includes at least an environmental benefit or an environmental impact. Other recommended actions can involve maintaining existing measures or taking no new actions.

At 110, the method includes generating a sustainability statement indicating the at least one recommended action.

At 112, the method includes outputting the sustainability statement for visualizing the sustainability goals. The sustainability statement can be formatted as a matrix representing sustainability metrics organized into executable actions, the matrix visually representing the tiered hierarchy of sustainability categories.

The above described system and method not only facilitate the visualization of sustainability goals but also enable the effective implementation and assessment of actions aimed at achieving these goals. Sustainability goals can be managed across various sectors within an organization. Through the combination of a user-friendly interface, robust data model, and algorithmic processing, a coherent and integrated approach can be offered for both visualizing and executing sustainability initiatives.

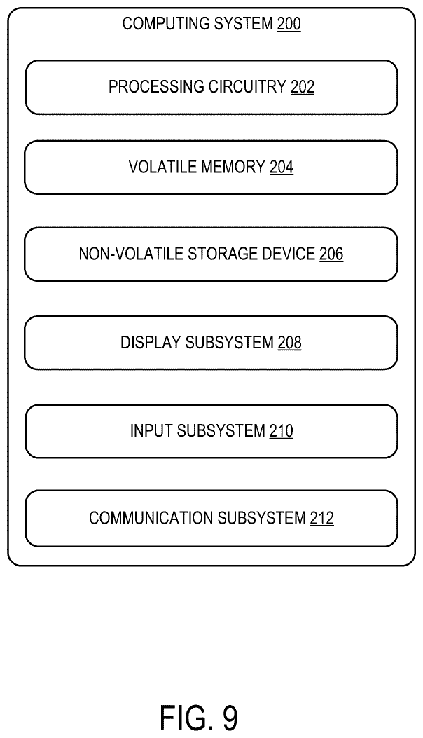

FIG. 9 schematically shows a non-limiting embodiment of a computing system 200 that can enact one or more of the methods and processes described above. Computing system 200 is shown in simplified form. Computing system 200 can embody the computing system 10 described above and illustrated in FIG. 1. Components of computing system 200 can be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 can optionally include a display subsystem 208, input subsystem 210, communication subsystem 212, and/or other components not shown in FIG. 1.

Processing circuitry typically includes one or more logic processors, which are physical devices configured to execute instructions. For example, the logic processors can be configured to execute instructions that are part of one or more applications, programs, routines, libraries, objects, components, data structures, or other logical constructs. Such instructions can be implemented to perform a task, implement a data type, transform the state of one or more components, achieve a technical effect, or otherwise arrive at a desired result.

The logic processor can include one or more physical processors configured to execute software instructions. Additionally or alternatively, the logic processor can include one or more hardware logic circuits or firmware devices configured to execute hardware-implemented logic or firmware instructions. Processors of the processing circuitry 202 can be single-core or multi-core, and the instructions executed thereon can be configured for sequential, parallel, and/or distributed processing. Individual components of the processing circuitry optionally can be distributed among two or more separate devices, which can be remotely located and/or configured for coordinated processing. For example, aspects of the computing system disclosed herein can be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 can be transformed—e.g., to hold different data.

Non-volatile storage device 206 can include physical devices that are removable and/or built in. Non-volatile storage device 206 can include optical memory, semiconductor memory, and/or magnetic memory, or other mass storage device technology. Non-volatile storage device 206 can include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 can include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” can be used to describe an aspect of computing system 200 typically implemented in software by a processor to perform a particular function using portions of volatile memory, which function involves transformative processing that specially configures the processor to perform the function. Thus, a module, program, or engine can be instantiated via processing circuitry 202 executing instructions held by non-volatile storage device 206, using portions of volatile memory 204. It will be understood that different modules, programs, and/or engines can be instantiated from the same application, service, code block, object, library, routine, API, function, etc. Likewise, the same module, program, and/or engine can be instantiated by different applications, services, code blocks, objects, routines, APIs, functions, etc. The terms “module,” “program,” and “engine” can encompass individual or groups of executable files, data files, libraries, drivers, scripts, database records, etc.

When included, display subsystem 208 can be used to present a visual representation of data held by non-volatile storage device 206. The visual representation can take the form of a graphical user interface (GUI). As the herein described methods and processes change the data held by the non-volatile storage device, and thus transform the state of the non-volatile storage device, the state of display subsystem 208 can likewise be transformed to visually represent changes in the underlying data. Display subsystem 208 can include one or more display devices utilizing virtually any type of technology. Such display devices can be combined with processing circuitry 202, volatile memory 204, and/or non-volatile storage device 206 in a shared enclosure, or such display devices can be peripheral display devices.

When included, input subsystem 210 can comprise or interface with one or more user-input devices such as a keyboard, mouse, touch screen, camera, or microphone.

When included, communication subsystem 212 can be configured to communicatively couple various computing devices described herein with each other, and with other devices. Communication subsystem 212 can include wired and/or wireless communication devices compatible with one or more different communication protocols. As non-limiting examples, the communication subsystem can be configured for communication via a wired or wireless local- or wide-area network, broadband cellular network, etc. In some embodiments, the communication subsystem can allow computing system 200 to send and/or receive messages to and/or from other devices via a network such as the Internet.

Further, the disclosure comprises configurations according to the following clauses.

Clause 1. A computing system for visualizing sustainability goals, comprising: memory storing a data model comprising a tiered hierarchy of sustainability categories; and processing circuitry configured to: receive user input of a product description for a product; categorize the product description using a tiered taxonomic hierarchy corresponding to the tiered hierarchy of sustainability categories; store the product description in the tiered hierarchy of sustainability categories of the data model; generate at least one recommended action based on the data model and the user input; generate a sustainability statement indicating the at least one recommended action; and output the sustainability statement for visualizing the sustainability goals, wherein the data model provides for a nesting of product description records within tiers of the tiered hierarchy of sustainability categories.

Clause 2. The computing system of Clause 1, wherein the sustainability statement is formatted as a matrix representing sustainability metrics organized into executable actions, the matrix visually representing the tiered hierarchy of sustainability categories.

Clause 3. The computing system of Clause 1 or 2, wherein the user input includes at least one of a role, the product, a sustainability theme, or a time frame for the product.

Clause 4. The computing system of any of Clauses 1 to 3, wherein the tiers of the data model include a plurality of themes, each of the plurality of themes including a plurality of capability categories, and each of the plurality of capability categories including a plurality of consideration categories.

Clause 5. The computing system of any of Clauses 1 to 4, wherein the plurality of themes include at least one of circularity, talent acquisition and retention, environmental responsibility, responsible supply chain, or in-service efficiency enablers.

Clause 6. The computing system of Clause 4, wherein the plurality of consideration categories include at least one of material recycling, material reclamation, or waste-to-landfill.

Clause 7. The computing system of any of Clauses 1 to 6, wherein the at least one recommended action includes at least an environmental benefit or an environmental impact.

Clause 8. The computing system of any of Clauses 1 to 7, wherein the user input is inputted into a user interface configured to display a matrix populated by data stored in the data model.

Clause 9. The computing system of any of Clauses 1 to 8, wherein the data model is an SQL database.

Clause 10. A method for visualizing sustainability goals, comprising: receiving user input of a product description for a product; categorizing the product description using a tiered taxonomic hierarchy corresponding to a tiered hierarchy of sustainability categories; storing the product description in the tiered hierarchy of sustainability categories of a data model comprising the tiered hierarchy of sustainability categories; generating at least one recommended action based on the data model and the user input; generating a sustainability statement indicating the at least one recommended action; and outputting the sustainability statement for visualizing the sustainability goals, wherein the data model provides for a nesting of product description records within tiers of the tiered hierarchy of sustainability categories.

Clause 11. The method of Clause 10, wherein the sustainability statement is formatted as a matrix representing sustainability metrics organized into executable actions, the matrix visually representing the tiered hierarchy of sustainability categories.

Clause 12. The method of Clause 10 or 11, wherein the user input includes at least one of a role, the product, a sustainability theme, or a time frame for the product.

Clause 13. The method of any of Clauses 10 to 12, wherein the tiers of the data model include a plurality of themes, each of the plurality of themes including a plurality of capability categories, and each of the plurality of capability categories including a plurality of consideration categories.

Clause 14. The method of Clause 13, wherein the plurality of themes include at least one of circularity, talent acquisition and retention, environmental responsibility, responsible supply chain, or in-service efficiency enablers.

Clause 15. The method of any of Clauses 10 to 14, wherein the plurality of consideration categories include at least one of material recycling, material reclamation, or waste-to-landfill.

Clause 16. The method of any of Clauses 10 to 15, wherein the at least one recommended action includes at least an environmental benefit or an environmental impact.

Clause 17. The method of any of Clauses 10 to 16, wherein the user input is inputted into a user interface configured to display a matrix populated by data stored in the data model.

Clause 18. The method of any of Clauses 10 to 17, wherein the data model is an SQL database.

Clause 19. A computing system for visualizing sustainability goals, comprising: memory storing a data model comprising a tiered hierarchy of sustainability categories; and processing circuitry configured to: receive user input of a product description for a product; categorize the product description using a tiered taxonomic hierarchy corresponding to the tiered hierarchy of sustainability categories; store the product description in the tiered hierarchy of sustainability categories of the data model; generate at least one recommended action based on the data model and the user input; generate a sustainability statement indicating the at least one recommended action; and output the sustainability statement for visualizing the sustainability goals, wherein the sustainability statement is formatted as a matrix representing sustainability metrics organized into executable actions, the matrix visually representing the tiered hierarchy of sustainability categories.

Clause 20. The computing system of Clause 19, wherein the user input is inputted into a user interface configured to display a matrix populated by data stored in the data model.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein can represent one or more of any number of processing strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for visualizing sustainability goals, comprising:
memory storing a data model comprising a tiered hierarchy of sustainability categories; and
processing circuitry configured to:
receive user input of a product description for a product;
categorize the product description using a tiered taxonomic hierarchy corresponding to the tiered hierarchy of sustainability categories;
store the product description in the tiered hierarchy of sustainability categories of the data model;
generate at least one recommended action based on the data model and the user input;
generate a sustainability statement indicating the at least one recommended action; and
output the sustainability statement for visualizing the sustainability goals, wherein
the data model provides for a nesting of product description records within tiers of the tiered hierarchy of sustainability categories.

2. The computing system of claim 1, wherein the sustainability statement is formatted as a matrix representing sustainability metrics organized into executable actions, the matrix visually representing the tiered hierarchy of sustainability categories.

3. The computing system of claim 1, wherein the user input includes at least one of a role, the product, a sustainability theme, or a time frame for the product.

4. The computing system of claim 1, wherein the tiers of the data model include a plurality of themes, each of the plurality of themes including a plurality of capability categories, and each of the plurality of capability categories including a plurality of consideration categories.

5. The computing system of claim 4, wherein the plurality of themes include at least one of circularity, talent acquisition and retention, environmental responsibility, responsible supply chain, or in-service efficiency enablers.

6. The computing system of claim 4, wherein the plurality of consideration categories include at least one of material recycling, material reclamation, or waste-to-landfill.

7. The computing system of claim 1, wherein the at least one recommended action includes at least an environmental benefit or an environmental impact.

8. The computing system of claim 1, wherein the user input is inputted into a user interface configured to display a matrix populated by data stored in the data model.

9. The computing system of claim 1, wherein the data model is an SQL database.

10. A method for visualizing sustainability goals, comprising:
receiving user input of a product description for a product;
categorizing the product description using a tiered taxonomic hierarchy corresponding to a tiered hierarchy of sustainability categories;
storing the product description in the tiered hierarchy of sustainability categories of a data model comprising the tiered hierarchy of sustainability categories;
generating at least one recommended action based on the data model and the user input;
generating a sustainability statement indicating the at least one recommended action; and
outputting the sustainability statement for visualizing the sustainability goals, wherein
the data model provides for a nesting of product description records within tiers of the tiered hierarchy of sustainability categories.

11. The method of claim 10, wherein the sustainability statement is formatted as a matrix representing sustainability metrics organized into executable actions, the matrix visually representing the tiered hierarchy of sustainability categories.

12. The method of claim 10, wherein the user input includes at least one of a role, the product, a sustainability theme, or a time frame for the product.

13. The method of claim 10, wherein the tiers of the data model include a plurality of themes, each of the plurality of themes including a plurality of capability categories, and each of the plurality of capability categories including a plurality of consideration categories.

14. The method of claim 13, wherein the plurality of themes include at least one of circularity, talent acquisition and retention, environmental responsibility, responsible supply chain, or in-service efficiency enablers.

15. The method of claim 13, wherein the plurality of consideration categories include at least one of material recycling, material reclamation, or waste-to-landfill.

16. The method of claim 10, wherein the at least one recommended action includes at least an environmental benefit or an environmental impact.

17. The method of claim 10, wherein the user input is inputted into a user interface configured to display a matrix populated by data stored in the data model.

18. The method of claim 10, wherein the data model is an SQL database.

19. A computing system for visualizing sustainability goals, comprising:
memory storing a data model comprising a tiered hierarchy of sustainability categories; and
processing circuitry configured to:
receive user input of a product description for a product;
categorize the product description using a tiered taxonomic hierarchy corresponding to the tiered hierarchy of sustainability categories;
store the product description in the tiered hierarchy of sustainability categories of the data model;
generate at least one recommended action based on the data model and the user input;
generate a sustainability statement indicating the at least one recommended action; and
output the sustainability statement for visualizing the sustainability goals, wherein
the sustainability statement is formatted as a matrix representing sustainability metrics organized into executable actions, the matrix visually representing the tiered hierarchy of sustainability categories.

20. The computing system of claim 19, wherein the user input is inputted into a user interface configured to display a matrix populated by data stored in the data model.
